(19) United States
(12) Patent Application Publication
(10) Pub. No.: US 2023/0169193 A1
(43) Pub. Date: Jun. 1, 2023

(54) IMAGE FORMING SYSTEM

(71) Applicant: KYOCERA Document Solutions Inc., Osaka (JP)

(72) Inventor: Yuzuru UCHIDA, Osaka-shi (JP)

(73) Assignee: KYOCERA Document Solutions Inc., Osaka (JP)

(21) Appl. No.: 18/059,032

(22) Filed: Nov. 28, 2022

(30) Foreign Application Priority Data
Nov. 29, 2021 (JP) 2021-193121

(51) Int. Cl. G06F 21/60; G06F 3/12

(52) U.S. Cl. CPC G06F 21/608; G06F 3/12

(57) ABSTRACT

An image forming system includes an image forming apparatus, a controller, and a management device managing keyword information for determining permission or prohibition of image formation and location information of the image forming apparatus. The controller includes an information acquiring section, an information comparing section, and an instruction section. The information acquiring section acquires data information of image and location information of the image forming apparatus. The information comparing section compares the acquired data information of the image and the location information of the image forming apparatus with the keyword information and the location information of the image forming apparatus each managed by the management device, and determines permission or prohibition of image formation. The instruction section instructs the image forming apparatus to execute or not to execute the image formation based on permission or prohibition of the image formation determined by the information comparing section.

### INCORPORATION BY REFERENCE

The present application claims priority under 35 U.S.C. § 119 to Japanese Patent Application No. 2021-193121, filed on Nov. 29, 2021. The contents of this application are incorporated herein by reference in their entirety.

### BACKGROUND

The present disclosure relates to an image forming system.

Demands for allowing or forbidding formation of images containing a specific keyword or formation of images instructed from a specific site are increasing.

Conventional image forming systems determine to allow or forbid image formation based on whether or not a location indicated in location information of an image forming apparatus is within a specific region, for example.

### SUMMARY

According to an aspect of the present disclosure, an image forming system includes an image forming apparatus, a controller, and a management device. The image forming apparatus performs image formation processing for forming an image on a sheet. The controller controls the image formation processing. The management device manages keyword information for determining permission or prohibition of image formation and location information of the image forming apparatus. The image forming apparatus, the controller, and the management device are mutually connected via a network. The controller includes an information acquiring section, an information comparing section, and art instruction section. The information acquiring section acquires data information of a to-be-formed image and location information of the image forming apparatus that has received an image formation instruction. The information comparing section compares the data information of the to-be-formed image and the location information of the image forming apparatus that are acquired by the information acquiring section with the keyword information and the location information of the image forming apparatus that are managed by the management device, and determines permission or prohibition of image formation. The instruction section instructs the image forming apparatus to execute or not to execute the image formation based on permission or prohibition of the image formation determined by the information comparing section.

### BRIEF DESCRIPTION OF THE DRAWINGS

FIG. 1 is a diagram illustrating the configuration of an image forming system according to an embodiment of the present disclosure.

FIG. 2 is a functional block diagram of the image forming system according to the embodiment of the present disclosure.

FIG. 3 is a flowchart depicting image formation processing performed by the image forming system according to the embodiment of the present disclosure.

FIG. 4 is a flowchart depicting image formation processing performed by the image forming system according to the embodiment of the present disclosure.

### DETAILED DESCRIPTION

The following describes an embodiment of the present disclosure with reference to the accompanying drawings. Note that elements that are the same or equivalent are indicated by the same reference signs in the drawings and description thereof is not repeated.

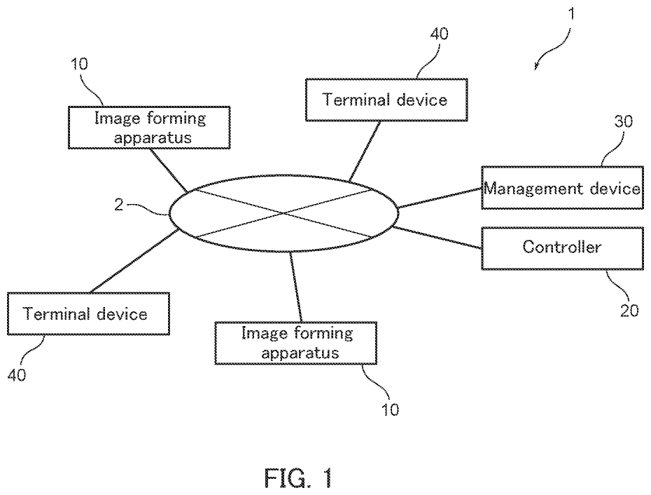

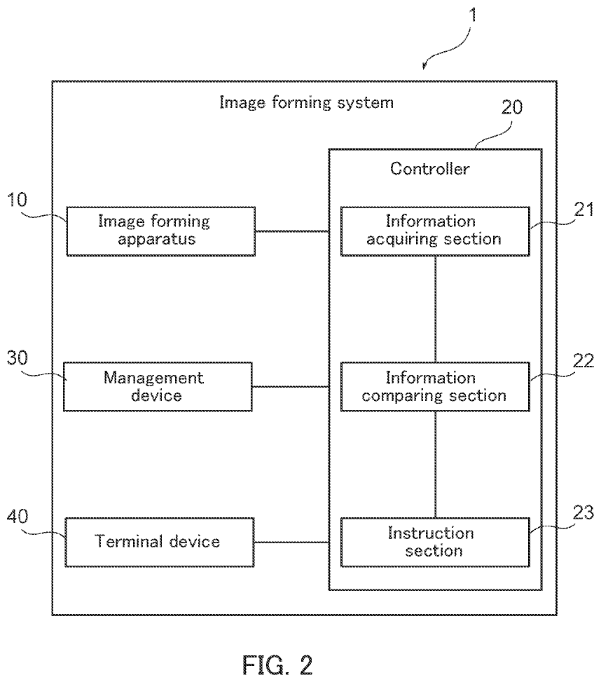

The following describes an image forming system 1 with reference to FIGS. 1 and 2. FIG. 1 is a diagram illustrating the configuration of the image forming system 1 according to an embodiment of the present disclosure. FIG. 2 is a functional block diagram of the image forming system 1 according to the embodiment of the present disclosure.

The image forming system 1 includes image forming apparatuses 10, a controller 20, a management device 30, and terminal devices 40. The image forming apparatuses 10, the controller 20, the management device 30, and the terminal devices 40 are mutually connected via a network 2. The image forming apparatuses 10, the controller 20, the management device 30, and the terminal devices 40 transmit and receive data to and from one another via the network 2.

Each of the image forming apparatuses 10 forms an image on a sheet (e.g., paper) according to an image formation instruction from a terminal device 40 under control of the controller 20. The image forming apparatuses 10 may he copiers, printers, or multifunction peripherals having a printing function.

Each of the terminal devices 40 issues an image formation instruction to one of the image forming apparatuses 10. The terminal devices 40 may be personal computers, tablet computers, smartphones, scanners, multifunction peripherals having a scanning function.

The management device 30 manages keyword information for determining permission or prohibition of image formation, location information of the image forming apparatuses 10, and location information of the terminal devices 40. The management device 30 is a server that having a function of storing the information and transmits and receives the information via the network 2.

The management device 30 manages the keyword information, the location information of each image forming apparatus 10, and the location information of each terminal device 40 in association with one another. Specifically, the management device 30 stores therein the location information of all of the image forming apparatuses 10 and the terminal devices 40 included in the image forming system 1. The management device 30 associates the location information of each image forming apparatus 10 with the keyword information for determining permission or prohibition of image formation and the location information of the terminal devices 40 with one another for management.

The keyword information, the location information of the image forming apparatuses 10, and the location information of the terminal devices 40 associated with one another are pre-stored in the management device 30. One way to add a new image forming apparatus 10, a new terminal device 40, or a new keyword for determining permission or prohibition of image formation to the image forming system 1 is to access the management device 30 via the network 2 and update the location information of the image forming apparatuses 10, the location information of the terminal devices 40, or the keyword information stored in the management device 30. Specifically, the new keyword information, the location information of the new image forming apparatus 10, or the location information of the new terminal device 40 is stored in the management device 30 in association with the old keyword information, the old location information of the image forming apparatuses 10, or the old location information of the terminal devices 40.

The controller 20 controls image formation processing. The controller 20 is a computer on which a central processing unit (CPU) and memory are boarded, for example. The controller 20 includes an information acquiring section 21, an information comparing section 22, and an instruction section 23.

The information acquiring section 21 acquires data information of a to-be-formed image, location information of an image forming apparatus 10 that has received an image formation instruction, and location information of a terminal device 40 that has issued the image formation instruction. The information acquiring section 21 transmits the acquired information to the information comparing section 22.

The information comparing section 22 compares the data information of the to-be-formed image, the location information of the image forming apparatus 10, and the location information of the terminal device 40 that are acquired by the information acquiring section 21 with the keyword information, the location information of the image forming apparatuses 10, and the location information of the terminal devices 40 that are managed by the management device 30, and determines permission or prohibition of image formation. The information comparing section 22 transmits determined permission or prohibition of the image formation tie instruction section 23. For example, for copying a document that includes multiple pages, the information comparing section 22 determines permission or prohibition of image formation page by page for the document.

The instruction section 23 instructs the image forming apparatus 10 to execute or not to execute the image formation based on permission or prohibition of the image formation determined by the information comparing section 22. Upon the information comparing section 22 determining permission of the image formation, the instruction section 23 instructs the image forming apparatus 10 to execute the image formation. Upon the information comparing section 22 determining prohibition of the image formation, the instruction section 23 instructs the image forming apparatus 10 not to execute the image formation.

The following describes a flow of image formation processing of the image forming system 1 according to the present embodiment of the present disclosure with reference to flowcharts.

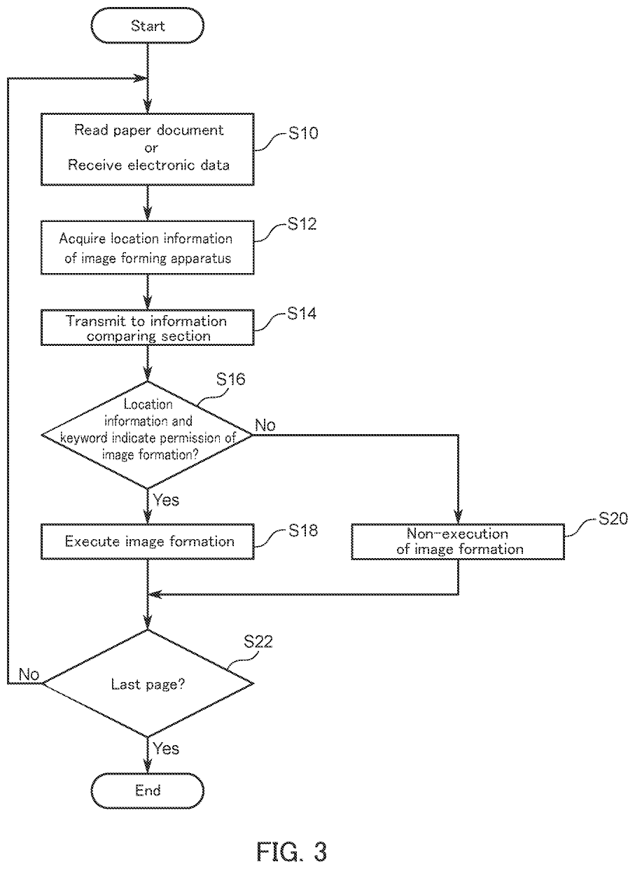

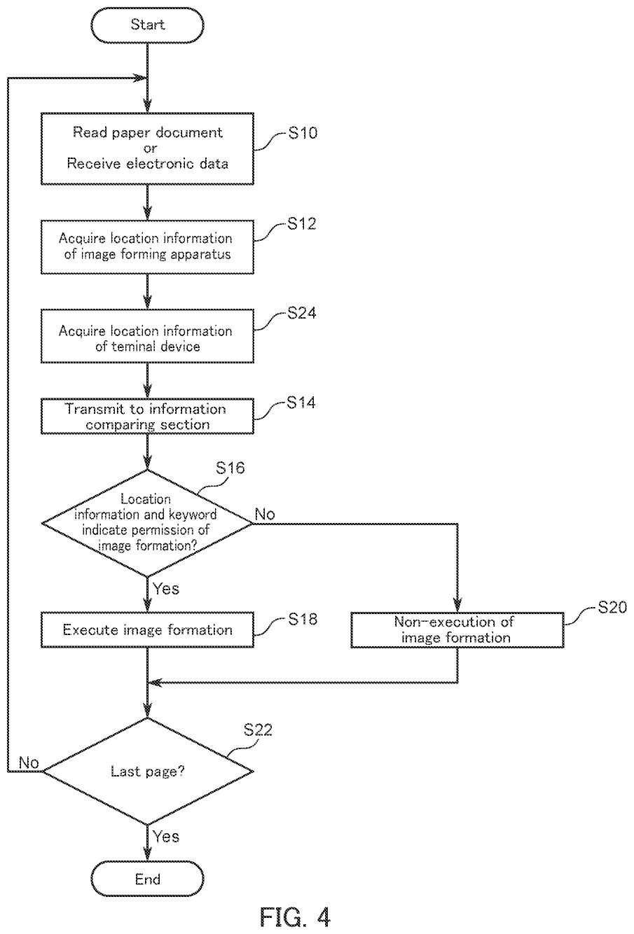

FIGS. 3 and 4 are flowcharts depicting image formation processing of the image forming system 1 according to the present embodiment of the present disclosure. In FIG. 3, permission or prohibition of image formation is determined regardless of the location information of a terminal device 40, while permission or prohibition of image formation is determined based on the location information of the terminal device 40 in FIG. 4.

The following first describes that permission or prohibition of image formation is determined regardless of the location information of a terminal device 40 with reference to FIG. 3.

First, a user specifies a to-be-formed image using a terminal device 40. Specifically, for copying a paper document, a terminal device 40 such as a scanner or a multifunction peripheral having a scanning function reads the document. For forming an image of for example electronic data, a terminal device 40 such as a personal computer that stores data information of a to-be-formed image therein transmits the data information of the to-be-formed image.

In a case in which an image forming apparatus 10 for image formation is predetermined for the terminal device 40, the terminal device 40 transmits the location information of the image forming apparatus 10, as the location information of an image forming apparatus 10 that is to perform output (image formation). In a case in which the user is allowed to select any of the image forming apparatuses 10 for image formation, the user designates the image forming apparatus 10 for image formation using the terminal device 40 that is reading the document or transmitting the data information of the to-be-formed image. In this case, the terminal device 40 transmits the location information of the image fanning apparatus 10 designated by the user as the location information of an image forming apparatus 10 that is to perform output (image formation).

The terminal device 40 transmits the data information of the to-be-formed image to the information acquiring section 21 (Step S10). The to-be-formed image may be read by the terminal device 40. For example, the terminal device 40 reads a paper document. Thereafter, the information acquiring section 21 receives the data information such as electronic data. At the same time, the information acquiring section 21 acquires the location information of the image forming apparatus 10 that has received an image formation instruction from the terminal device 40 (Step S12).

The information acquiring section 21 transmits the acquired data information of the to-be-formed image and the location information of the image forming apparatus 10 to the information comparing section 22 (Step S14).

The information comparing section 22 receives the data information of the to-be-formed image and the location information of the image forming apparatus 10 from the information acquiring section 21. In this case, the data information of the to-be-formed image of for example a paper document is received as image data. The information comparing section 22 converts the data information received as the image data into a character code using an optical character recognition (OCR) function provided in the controller 20.

Moreover, the information comparing section 22 reads out the keyword information and the location information of the image forming apparatuses 10 stored in association with each other from the management device 30.

Thereafter, the information comparing section 22 compares the data information of the to-be-formed image and the location information of the image forming apparatus 10 that are acquired by the information acquiring section 21 with the keyword information and the location information of the image forming apparatuses 10 that are read from the management device 30, and determines permission or prohibition of image formation (Step S16). The information comparing section 22 determines permission or prohibition of the image formation from the first page in a case in which the document includes multiple pages.

Specifically, the management device 30 stores therein multiple pieces of keyword information and location information of the image forming apparatuses 10. Examples of the keyword information include keyword information indicating that a specific image forming apparatus A is allowed to form images including a specific keyword X, and keyword information indicating that a specific image forming apparatus B is forbidden to form images including a specific keyword Y. The information comparing section 22 performs comparison to determine whether or not the data information of the to-be-formed image includes a keyword for which image formation is permitted or prohibited for the image forming apparatus 10 that has received the image formation instruction. If the data information of the to-be-formed image includes a keyword for which the image formation is permitted, the information comparing section 22 determines permission of the image formation. If the data information of the to-be-formed image includes a keyword for which the image formation is prohibited, the information comparing section 22 determines prohibition of the image formation.

The information comparing section 22 transmits permission or prohibition of the image formation to the instruction section 23. The instruction section 23 instructs the image forming apparatus 10 to execute or not to execute the image formation based on the received permission or prohibition of the image formation determined by the information comparing section 22. Specifically, upon receiving permission of the image formation from the information comparing section 22, the instruction section 23 instructs the image forming apparatus 10 to execute the image formation (Step S18). Upon receiving prohibition of the image formation from the information comparing section 22, the instruction section 23 instructs the image forming apparatus 10 not to execute the image formation (Step S20). For instructing non-execution of image formation, the instruction section 23 causes the image forming apparatus 10 to display a message indicating image formation is not to be executed for user notification.

The information comparing section 22 having determined permission or prohibition of image formation for the first page determines whether or not the to-be-formed image is an image of the last page of the document (Step S22). The same determination of permission or prohibition of image formation will be made for the next page if there are any pages for which image formation is to be executed. The image forming processing ends if the to-be-formed image is an image of the last page of the document.

The following describes that permission or prohibition of image formation is determined based on the location information of a terminal device 40 with reference to FIG. 4.

First, the user specifies a to-be-formed image using a terminal device 40 as in the case of determination as to permission or prohibition of image formation regardless of the location information of the terminal device 40. In this case, the location information of an image forming apparatus 10 is transmitted as in the case of determination as to permission or prohibition of image formation regardless of the location information of the terminal device 40.

The terminal device 40 transmits data information of the to-be-formed image to the information acquiring section 21 (Step S10). The to-be-formed image may be read by the terminal device 40. At the same time, the information acquiring section 21 acquires the location information of the image forming apparatus 10 that has received an image formation instruction from the terminal device 40 (Step S12). Moreover, the information acquiring section 21 acquires the location information of the terminal device 40 that has issued the image formation instruction (Step S24).

The information acquiring section 21 transmits the acquired data information of the to-be-formed image, the location information of the image forming apparatus 10, and the location information of the terminal device 40 to the information comparing section 22 (Step S14).

The information comparing section 22 receives the data information of the to-be-formed image, the location information of the image forming apparatus 10, and the location information of the terminal device 40 from the information acquiring section 21. The information comparing section 22 converts the image data information of the to-be-formed image of for example a paper document, into a character code using an OCR function as in the case of determination of permission or prohibition of image formation regardless of the location information of the terminal device 40.

Moreover, the information comparing section 22 reads out the keyword information, the location information of the image forming apparatuses 10, and the location information of the terminal devices 40 stored in association with each other from the management device 30.

Thereafter, the information comparing section compares the data information of the to-be-formed image, the location information of the image forming apparatus 10, and the location information of the terminal device 40 that are acquired by the information acquiring section 21 with the keyword information, the location information of the image forming apparatuses 10, and the location information of the terminal devices 40 that are read out from the management device 30 and determines permission or prohibition of image formation (Step S16). The information comparing section 22 determines permission or prohibition of image formation from the first page in a case in which the document includes multiple pages.

Specifically, the management device 30 stores therein multiple pieces of keyword information, location information of the image forming apparatuses 10, and location information of the terminal devices 40. Examples of the keyword information include keyword information indicating that a specific image forming apparatus A is permitted to execute image formation for a specific terminal device P, keyword information indicating that a specific image forming apparatus B is prohibited from executing image formation for a specific terminal device Q, keyword information indicating that a specific image forming apparatus C for a specific terminal device R is permitted to form images including a specific keyword X, and keyword information indicating that a specific image forming apparatus D for a specific terminal device S prohibited from forming images including a specific keyword Y. The information comparing section 22 performs comparison to determine whether the image forming apparatus 10 having received an image formation instruction is permitted to execute image formation or prohibited from executing image formation for the terminal device 40 that has issued the image formation instruction. The information comparing section 22 also performs comparison to determine whether the data information of the to-be-formed image includes a keyword indicating permission or prohibition of image formation for the image forming apparatus 10 that has received an image formation instruction. The information comparing section 22 determines permission of image formation either or both when the image forming apparatus 10 having received an image formation instruction is permitted to execute image formation for the terminal device 40 that has issued the image formation instruction, and when the data information of the to-be-formed image includes a keyword indicating permission of image formation. The information comparing section 22 determines prohibition of image formation either or both when the image forming apparatus 10 having received an image formation instruction is prohibited from executing image formation for the terminal device 40 that has issued the image formation instruction, and when the data information of the to-be-formed image includes a keyword indicating prohibition of image formation.

The information comparing section 22 transmits permission or prohibition of the image formation to the instruction section 23. The instruction section 23 instructs the image forming apparatus 10 to execute or not to execute the image formation based on the received permission or prohibition of the image formation determined by the information comparing section 22. Specifically, upon receiving permission of image formation from the information comparing section 22, the instruction section 23 instructs the image forming apparatus 10 to execute the image formation (Step S18). Upon receiving prohibition of image formation from the information comparing section 22, the instruction section 23 instructs the image forming apparatus 10 not to execute the image formation (Step S20). When the image formation is not to be executed, the instruction section 23 causes the image forming apparatus 10 to display a message indicating that image formation is not to be executed for user notification.

The information comparing section 22 having determined permission or prohibition of image formation for the first page determines whether or not the to-be-formed image is an image of the last page of the document (Step S22). The same determination as to permission or prohibition of image formation will be made for the next page if there are any pages for which image formation is to be executed. The image formation processing ends if the to-be-formed image is an image of the last page of the document.

As described above, the management device 30 in the image forming system 1 of the present disclosure pre-stores location information of the image forming apparatuses 10 and keyword information for determining permission or prohibition of image formation. The controller 20 determines permission or prohibition of image formation based on the keyword information and the location information of the image forming apparatuses 10 stored in the management device 30. As such, information of images using a specific image forming apparatus 10, it is possible to permit or prohibit image formation for an image that includes a specific keyword. In other words, permission or prohibition of image formation can be controlled according to a to-be-formed image and the location of an image forming apparatus 10.

Moreover, the management device 30 pre-stores therein location information of a terminal device 40 that has issued the image formation instruction. The controller 20 determines permission or prohibition of image formation based on the keyword information, the location information of the image forming apparatuses 10, and the location information of terminal devices 40 stored in the management device 30. As such, it is possible to permit or prohibit a specific image forming apparatus 10 to execute or from executing image formation according to an image formation instruction from a specific terminal device 40.

The following exemplifies application of the image forming system 1 of the present embodiment. For a document containing confidential information, a keyword indicating the confidential information can be pre-stored as keyword information in the management device 30. This can prohibit from copying the document containing the keyword. In a case in which a specific image forming apparatus 10 is permitted to form images containing a keyword indicating the confidential information, the document containing the confidential information can be copied by only the specific image forming apparatus 10 through pre-storage of the location information of the specific image forming apparatus 10 in the management device 30 in association with the keyword information.

For images that are unfavorable to be copied under copyright law, images containing the keyword can be prohibited from being copied through pre-storage of the keyword contained in the images in the management device 30 as keyword information, In this way, security enhancement can be achieved by prohibiting from copying images containing specific keyword information. Using information pre-stored in the management device 30 may also contribute to user convenience in image formation.

Permission or a prohibition of image formation is determined page by page for a document that includes multiple pages. Therefore, image formation is only permitted for a page that is permitted for image formation. In other words, image formation can be controlled page by page for a document.

An embodiment of the present disclosure has been described above with reference to the drawings. However, the present disclosure is not limited to the above embodiments, and can be implemented in various aspects within a scope not departing from the gist of the present disclosure. Also, a plurality of elements of configuration disclosed in the foregoing embodiment can be combined as appropriate to form various disclosures. For example, some of the elements of configuration disclosed in the embodiment may be omitted. Moreover, each element shown in the above embodiment is an example and is not particularly limited, and various alterations are possible within the scope not substantially departing from the configuration of the present disclosure.

Permission or prohibition of image formation is determined page by page for the document in the above embodiment, which should not be taken to limit the present disclosure. For example, for prohibiting image formation for all pages of a document containing a specific keyword, execution or non-execution of image formation can be determined by determining permission or prohibition of image formation for all the pages in advance.

The management device 30 in the present disclosure manages but is not limited to manage the location information of terminal devices 40 as in the above embodiment. For example, management of the location information of the terminal devices 40 is unnecessary in an image forming system 1 that executes image formation according to an image formation instruction from any of the terminal devices 40 without identifying the terminal device 40 as described with the flowchart of FIG. 3. In other words, the management device 30 of the image forming system 1 may not manage the location information of terminal devices 40. Accordingly, acquisition of location information of the terminal devices 40 by information acquiring section 21 and comparison with location information of the terminal devices 40 by the information comparing section 77 may be unnecessary.

The image forming apparatuses 10 and the terminal devices 40 are separated from each other as described in the above embodiment, which should not be taken to limit the present disclosure. An image forming apparatus 10 and a terminal device 40 may be incorporated in a single multifunction peripheral having a printing function and a scanning function. In this case, the printing function of the multifunction peripheral is fulfilled by the image forming apparatus 10 and the scanning function of the multifunction peripheral is fulfilled by the terminal device 40.

The controller 20 is connected to the image forming apparatuses 10 and the management device 30 via the network 2 in the above embodiments, which should not be taken to limit the present disclosure. The controller 20 may be incorporated in the image forming apparatus 10 or the management device 30, for example.

What is claimed is:

1. An image forming system, comprising:
an image forming apparatus that performs image formation processing for forming an image on a sheet;
a controller that controls the image formation processing; and
a management device that manages keyword information for determining permission or prohibition of image formation and location information of the image forming apparatus, wherein
the image forming apparatus, the controller, and the management device are mutually connected via a network,
the controller includes an information acquiring section, an information comparing section, and an instruction section,
the information acquiring section acquires data information of a to-be-formed image and location information of the image forming apparatus that has received an image formation instruction,
the information comparing section compares the data information of the to-be-formed image and the location information of the image forming apparatus that are acquired by the information acquiring section with the keyword information and the location information of the image forming apparatus that are managed by the management device, and determines permission or prohibition of image formation for the to-be-formed image,
the instruction section instructs the image forming apparatus to execute or not to execute the image formation for the to-be-formed image based on the permission or the prohibition of the image formation for the to-be-formed image determined by the information comparing section.

2. The image forming system according to claim 1, further comprising
a terminal device that is connected to the network and that issues the image formation instruction, wherein
the management device further manages location information of the terminal device,
the information acquiring section acquires location information of the terminal device that has issued the image formation instruction, the information comparing section compares the data information of the to-be-formed image, the location information of the image forming apparatus, and the location information of the terminal device that are acquired by the information acquiring section with the keyword information, the location information of the image forming apparatus, and the location information of the terminal device that are managed by the management device, and determines permission or prohibition of the image formation for the to-be-formed image.

3. The image forming system according to claim 1, wherein
the information comparing section determines permission or prohibition of mage formation page by page for images of a document including multiple pages.
